(19) United States
(12) Patent Application Publication
(10) Pub. No.: US 2021/0120942 A1
(43) Pub. Date: Apr. 29, 2021

(54) EXPANDABLE DEVICE FOR A PORTABLE ELECTRONIC DEVICE

(71) Applicant: PopSockets LLC, Boulder, CO (US)

(72) Inventors: Vanessa Cantoli-Alves, San Francisco, CA (US); Karla-Sofia Zapata-Garcia, San Francisco, CA (US); Randy Yang Chiang, San Francisco, CA (US); Lawrence Herman Fong, San Francisco, CA (US)

(21) Appl. No.: 17/139,311

(22) Filed: Dec. 31, 2020

Related U.S. Application Data
(62) Division of application No. 16/522,317, filed on Jul. 25, 2019, now abandoned.
(60) Provisional application No. 62/814,121, filed on Mar. 5, 2019.
(60) Provisional application No. 62/713,844, filed on Aug. 2, 2018.

(51) Int. Cl. A45F 5/00; A45D 40/18

(52) U.S. Cl. CPC A45F 5/00; A45F 2200/0516; A45F 2005/002; A45D 40/18

(57) ABSTRACT

An expandable device includes a platform having top and bottom sides, a body having a first end and a second end, the second end being operably coupled to the platform, a button operably coupled to the first end of the body, and a storage receptacle defined by at least one of the button, the platform, and the body. The body is movable between an expanded configuration and a collapsed configuration.

### CROSS REFERENCE TO RELATED APPLICATIONS

This application is a divisional of and claims priority to U.S. application Ser. No. 16/522,317, filed on Jul. 25, 2019, which in turn claims the benefit of U.S. Provisional Application No. 62/713,844, filed on Aug. 2, 2018, and U.S. Provisional Application No. 62/814,121, filed Mar. 5, 2019. The entire contents of the priority applications are hereby incorporated by reference.

### FIELD OF THE DISCLOSURE

The present disclosure generally relates to an expandable device and, more particularly, to expandable devices that can be attached to a portable electronic device or a case for a portable electronic device and used as grips, stands, or for other purposes.

### BACKGROUND

Portable electronic devices, such as MP3 players and smart phones, are often housed in protective covers or cases in order to protect the device from damage, provide a grip for handling the device, and/or provide a stand for propping the device on a surface. Such cases increase the effective size of the device. Expandable devices and accessories, which may be attached directly to the device or to the case protecting the device, are used for a variety of functions, including propping the device on a surface and providing an expandable grip for handling the device. The expandable devices have decorative buttons, which may display logos, decals, symbols, or other artistic renderings.

### SUMMARY

In accordance with one aspect, an expandable device includes a platform having top and bottom sides, a body having a first end and a second end, the second end being operably coupled to the platform, a button operably coupled to the first end of the body, and a storage receptacle defined by at least one of the button, the platform, and the body. The body is movable between an expanded configuration and a collapsed configuration.

In some approaches, the button may define the entirety of the storage receptacle. The button may be removably coupled to the expandable device. In some examples, the button is coupled to the body via at least one of a threaded connection, a hinged connection, a friction fit connection, a snap fit (or living hinge) connection, or a childproof sealing mechanism.

In some examples, the expandable device may further include a cosmetic product disposed in the storage receptacle. A mirror may be operably coupled to the button to assist in application of the cosmetic product. In some forms, the storage receptacle is dimensioned to accommodate at least one of a cosmetic product, a food product, a fluid, a medicinal product, an electronic component, and/or any other suitable or desirable object or material.

In some forms, the storage receptacle may include a release mechanism coupled to a bottom surface thereof. The release mechanism may be configured to release the body and the button from the platform. The release mechanism may be coupled to a flexible and/or a rigid surface of the storage receptacle.

In accordance with a second aspect, an expandable device includes a platform having top and bottom sides, a body having a first end and a second end, the second end being operably coupled to the platform, and a button operably coupled to the first end of the body. The body is movable between an expanded configuration and a collapsed configuration. The button includes a bottom surface, a sidewall, and a top that cooperate to define a storage receptacle.

### BRIEF DESCRIPTION OF THE DRAWINGS

The above needs are at least partially met through provision of the expandable device for a portable electronic device described in the following detailed description, particularly when studied in conjunction with the drawings, wherein:

FIG. 1 illustrates a cross-sectional side elevation view of an expandable device in accordance with various embodiments;

FIG. 2 illustrates a cross-sectional side elevation view of the expandable device of FIG. 1 in an open configuration in accordance with various embodiments;

FIG. 3 illustrates a cross-sectional side elevation view of an example expandable device having a threaded engagement portion in accordance with various embodiments;

FIG. 4 illustrates a cross-sectional side elevation view of a second example expandable device having an alternate storage receptacle in accordance with various embodiments;

FIG. 5 illustrates a cross-sectional side elevation view of a third example expandable device having a release mechanism in accordance with various embodiments;

FIG. 6 illustrates an isometric view of the third example expandable device in accordance with various embodiments;

FIG. 7 illustrates an exploded view of the expandable device of FIG. 6, including an example button, an example body including an example disk, an example hub, and an example platform in accordance with various embodiments;

FIG. 8 illustrates a front, cross-sectional view of the expandable device taken at I-I of FIG. 6 in accordance with various embodiments;

FIG. 9 illustrates a side, cross-sectional view of the expandable device taken at II-II of FIG. 6 in accordance with various embodiments;

FIG. 10 illustrates a front, cross-sectional view of the expandable device of FIG. 6 in a collapsed configuration in accordance with various embodiments;

FIG. 11 illustrates a bottom view of the button of FIG. 6 in accordance with various embodiments;

FIG. 12 illustrates a top view of the connecting disk of FIG. 6 in accordance with various embodiments;

FIG. 13 illustrates a side view of the connecting disk of FIG. 12 in accordance with various embodiments;

FIG. 14 illustrates a isometric view of the hub of FIG. 6 in accordance with various embodiments;

FIG. 15 illustrates a bottom view of the hub of FIG. 14 in accordance with various embodiments;

FIG. 16 illustrates a top view of the platform of FIG. 5 in accordance with various embodiments;

FIG. 17 illustrates a side, cross-sectional view of the platform taken at of FIG. 14 in accordance with various embodiments;

FIG. 18 illustrates a front, cross-sectional view of the platform taken at Iv-Iv of FIG. 14 in accordance with various embodiments;

FIG. 19 illustrates a front, cross-sectional view of a fourth example expandable device constructed in accordance with various embodiments;

FIG. 20 illustrates a side, cross-sectional view of the expandable device of FIG. 19 in accordance with various embodiments;

FIG. 21 illustrates a top view of a second example connector of the expandable device of FIG. 19 in accordance with various embodiments;

FIG. 22 illustrates a perspective view of a fifth example expandable device constructed in accordance with various embodiments;

FIG. 23 illustrates a perspective view of a sixth alternative expandable device in accordance with various embodiments;

FIG. 24 is a front elevation view of the expandable device of FIG. 23 in accordance with various embodiments;

FIG. 25 is an exploded perspective view of the expandable device of FIGS. 23 and 24 in accordance with various embodiments;

FIG. 26 is a perspective view of a seventh example expandable device in accordance with various embodiments;

FIG. 27 is an exploded perspective view of the expandable device of FIG. 26 in accordance with various embodiments;

FIG. 28 is a front elevation view of the expandable device of FIGS. 26 and 27 prior to coupling the lid to the body in accordance with various embodiments;

FIG. 29 illustrates a side elevation view of the expandable device of FIGS. 26-28 prior to coupling the button to the body in accordance with various embodiments;

FIG. 30 illustrates a side elevation view of the expandable device of FIGS. 26-29 in a coupled configuration in accordance with various embodiments;

FIG. 31 illustrates a perspective view of an eighth example expandable device in accordance with various embodiments;

FIG. 32 illustrates an exploded perspective view of the expandable device of FIG. 31 in accordance with various embodiments;

FIG. 33 illustrates a side elevation view of a ninth example expandable device in accordance with various embodiments; and

FIG. 34 illustrates a side elevation view of the expandable device of FIG. 33 in an opened configuration in accordance with various embodiments.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, expandable devices for portable electronic devices are provided that include a platform and an expanding mechanism that is movable relative to the platform between a collapsed configuration and an expanded configuration. The expandable devices may further include a button coupled to the expanding mechanism. The expandable device defines a storage receptacle to securely store any number of desired personal items.

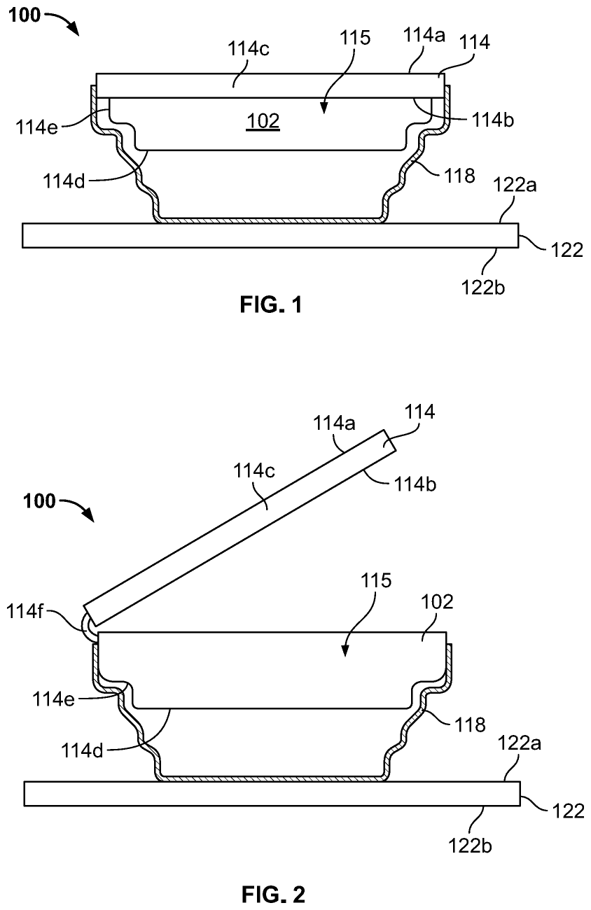

A first embodiment of an expandable device 100 is shown in FIGS. 1-3. The expandable device 100 includes a platform 122 having a top or upper side 122a and a bottom or lower side 122b, a collapsible and/or expandable mechanism or body 118 operably coupled to the platform 122, a button 114 having a top or upper side 114a and a bottom or lower side 114b. The expandable device 100 further includes a storage receptacle 102.

The platform 122 may have any desired shape (e.g., an annular shape) and is preferably constructed from metal or plastic material, though other suitable materials (e.g., cardboard) can be used. In any case, the bottom side 122b of the platform 122 is generally configured to be directly or indirectly coupled (e.g., attached, mounted) to a portable media player (e.g., an MP3 player, a smart phone, a tablet) or a case of such a portable media player. To this end, the platform 122 can, in some cases, include a securing element known to one of ordinary skill in the art, such as, for example, adhesive, glue, tape, a suction cup, a snap-fit connection, a friction fit, other means, or combinations thereof. Alternatively, in other examples, the platform 122 can be integrally formed with the portable media player or the case for the portable media player.

The body 118 generally facilitates movement of the expandable device 100 between an expanded configuration (illustrated in FIGS. 1-4) and a collapsed configuration (not shown), and to retain the expandable device 100 in the desired configuration (expanded or collapsed). The body 118 may take the form of a tubular membrane, skin, curtain, case, enclosure, shell, cover, etc., and may include, surround, or contain a biasing member (e.g., a coil spring) that is arranged between the platform 122 and the button 114.

As stated, the button 114 includes the top or upper side 114a and the bottom or inner side 114b that define a lid 114c and is operably coupled to the body 118. The button 114 may have an annular shape. In other examples, however, the button 114 may have a rectangular, square, triangular, irregular, or other shape. The button 114 in this example also has an outer diameter that is larger than an outer diameter of the platform 122, though this need not be the case. Like the platform 122, the button 114 is preferably constructed from metal or plastic material, though other suitable materials can be used.

The button 114 may be removable from the expandable device 100. The button 114 may have artistic value (e.g., the button 114 may include an artistic rendering, a logo, a symbol, text, or a decal), the button 114 may provide a grip that allows a user to slide their fingers between the bottom side 114b and the platform 122 when the body 118 is in the expanded configuration such that the top side 114a of the button 114 is disposed adjacent to the palm of the user's hand, and may also provide a space in which a cord, such as a cord for earphones, may be wrapped and stored around a portion of the platform 122. As such, in some examples, it may be desirable to remove the button 114 and replace it with another button 114 that features a different aesthetic design and/or provides a different grip so as to change the look and/or function of the expandable device 100.

In some examples, and as illustrated in FIGS. 1-3, the button 114 may include a base or bottom surface 114d and a sidewall 114e that cooperate with the lid 114c to define the storage receptacle 102. Specifically, the button 114 may have an interior volume 115 to accommodate any number of items. For example, the storage receptacle 102 may be dimensioned to accommodate a cosmetic product, a food product, a fluid, a medicinal product, an electronic component, and/or any other suitable or desirable product. Cosmetic products may include lip balm, eye shadow, blush, mascara, hair gel, etc. Food products could include nutritional/energy gels, candy, powdered nutritional products, mints, gum, etc. Medicinal products might include an antibiotic salve, bug repellant salve or oils, after bite treatment, hydrocortisone cream, calamine lotion, sunscreen, etc. Other items such as ear rings, a spare key, etc. may also be stored in the compartment. The storage compartment 102 may include partitions or other components (not shown) to assist in accommodating desired products such as, for example, different shades of a cosmetic product or different flavors of a lip balm. In some examples, the button 114 may include a mirror (not shown) on the inside and/or outside surface to assist in applying the cosmetic product to a user's face. The bottom surface 114d and/or the sidewall 114e may be constructed from a rigid, semi-flexible, and/or flexible material.

In some examples, and as illustrated in FIG. 2, the button 114 may include a hinge 114f that couples the lid 114c to the sidewall 114e. The hinge 114f may also include a release mechanism allowing the lid 114c to be removed from the sidewall 114e. In other examples, the lid 114c may be frictionally fit, threadably coupled, snap fir, press-fit, or otherwise coupled to the sidewall 114e. In yet other examples, the lid 114c may include a childproof sealing mechanism that restricts access to the storage receptacle 102 until a suitable force or other motion is exerted on the button 114. In some versions, the lid 114c may include a rupturable seal to ensure only one-time use. In some versions, the compartment and the contents of the compartment can be sterile prior to opening by a user.

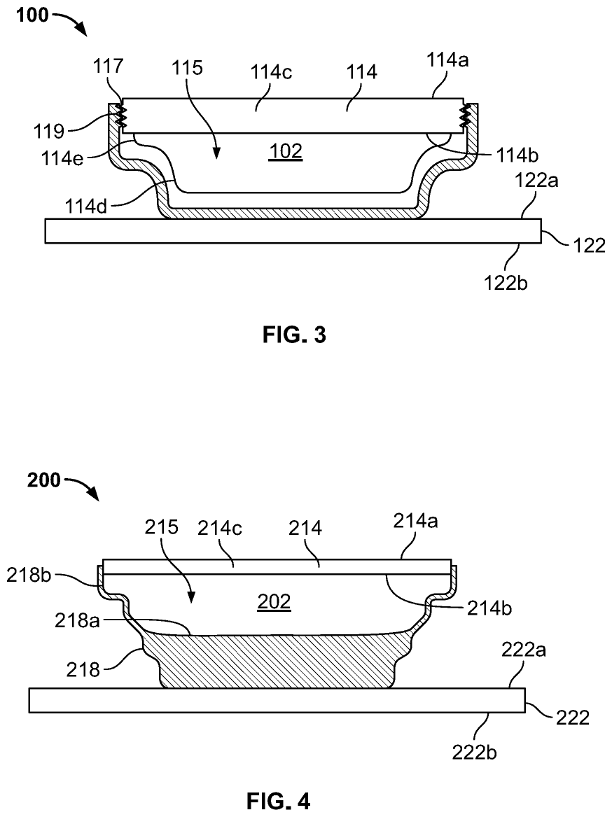

As illustrated in FIG. 3, the button 114 may be threadably coupled to the body 118 via threads 117, 119 disposed on the lid 114c and the body 118, respectively. In other examples, the threads may be disposed on the sidewall 114e of the button 114. Other locations are possible.

In operation, the expandable device 100 may be moved from the expanded configuration to the collapsed configuration by overcoming any biasing forces applied by resilient members. Generally speaking, the user of the expandable device 100 may accomplish this by grabbing or grasping the button 114 and moving (e.g., pushing) the button 114 towards the platform 122. The expandable device 100 may include any number of retaining components to maintain the expandable device 100 in the collapsed configuration. The button 114 may be positioned in the expanded configuration by grasping or pulling the button 114 away from the platform 122 with a sufficient force to overcome the force of any retaining components used to secure the expandable device 100 in the collapsed configuration. Upon doing so, if the expandable device 100 is equipped with a resilient member or members, the button 114 will be urged towards, and maintained in, an expanded configuration.

As illustrated in FIG. 4, an alternative expandable device 200 is provided. It will be appreciated that the expandable device 200 illustrated in FIG. 4 may include similar features to the expandable device 100, and thereby elements illustrated in FIG. 4 are designated by similar reference numbers indicated on the embodiment illustrated in FIGS. 1-3, increased by 100. Accordingly, these features will not be described in substantial detail.

In these example depicted in FIG. 4, the body 218, combined with the lid 214c, define the storage receptacle 202. In other words, in this form, the body 218 includes a bottom surface 218a and a sidewall 218b which define an interior volume 215. The bottom surface 218a and/or the sidewall 218b may be constructed from a rigid, semi-flexible, and/or flexible material. Upon removing the lid 214 from the expandable device 200, the storage receptacle 202 will remain coupled to, and disposed within, the expandable device 200. In any of these examples, the lid 214 may be coupled to the body 218 via any of the previously-discussed approaches (e.g., via a hinged, threaded, friction-fit, snap-fit, childproof sealing mechanisms, etc.).

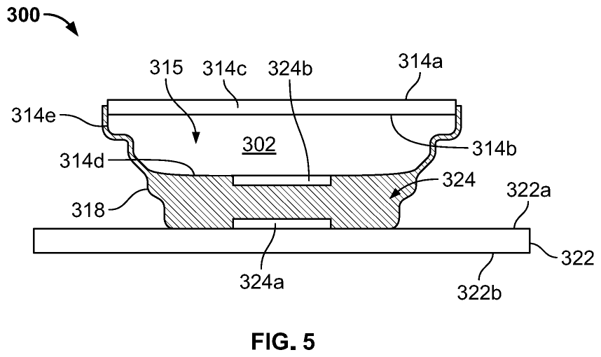

The above expandable devices 100, 200 may include any number of additional features as desired to improve and/or increase its functionality. For example, approaches described herein may include a release mechanism to allow the body and the button to be selectively decoupled from the platform. As illustrated in FIG. 5, generally speaking, an expandable device 300 may include similar features to the expandable devices 100, 200, and thereby elements illustrated in FIG. 5 are designated by similar reference numbers indicated on the embodiments illustrated in FIGS. 1-4, increased by 100 or 200, respectively. Accordingly, these features will not be described in substantial detail. The expandable device 300 in this example additionally includes a releasable or locking device or mechanism 324 that allows a portion of the expandable device 300 (e.g., the body 318 and/or the button 314) to be disengaged from the platform 322. In some approaches, the platform 322 may carry a first release component 324a, and a portion of the button 318 (e.g., the bottom surface 314d) may carry a second release component 324b. It is understood that in some examples where the storage container is defined by the body and not the button, the lower surface of the body may carry the second release component 324b. In any event, the second release component 324b may be coupled to a rigid, semi-rigid, and/or flexible bottom surface.

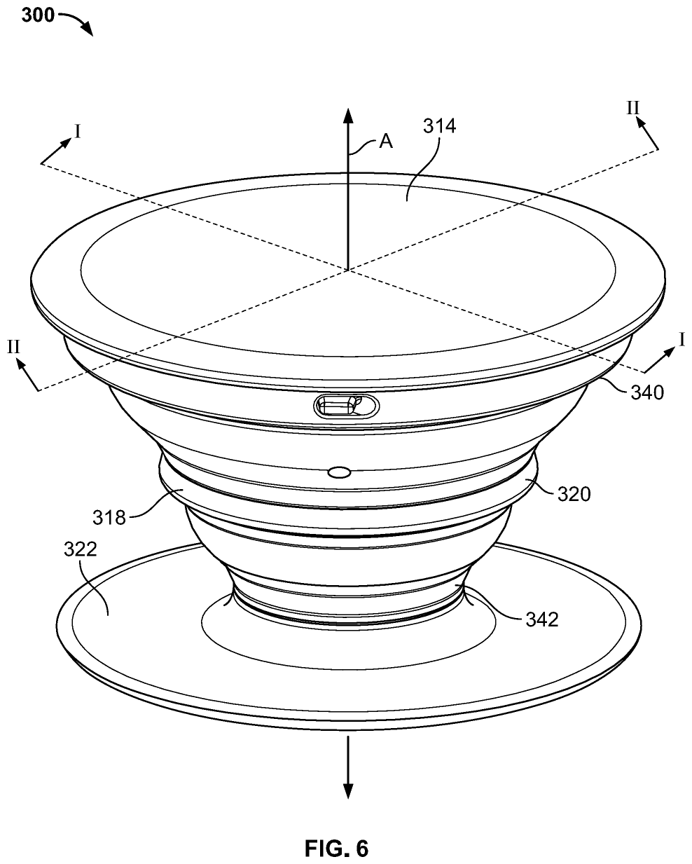

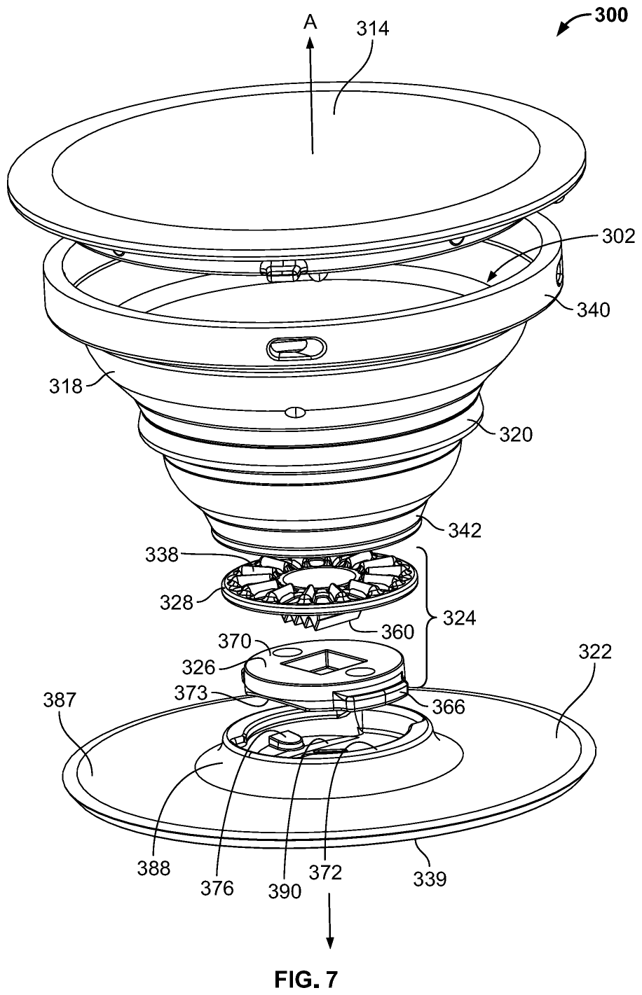

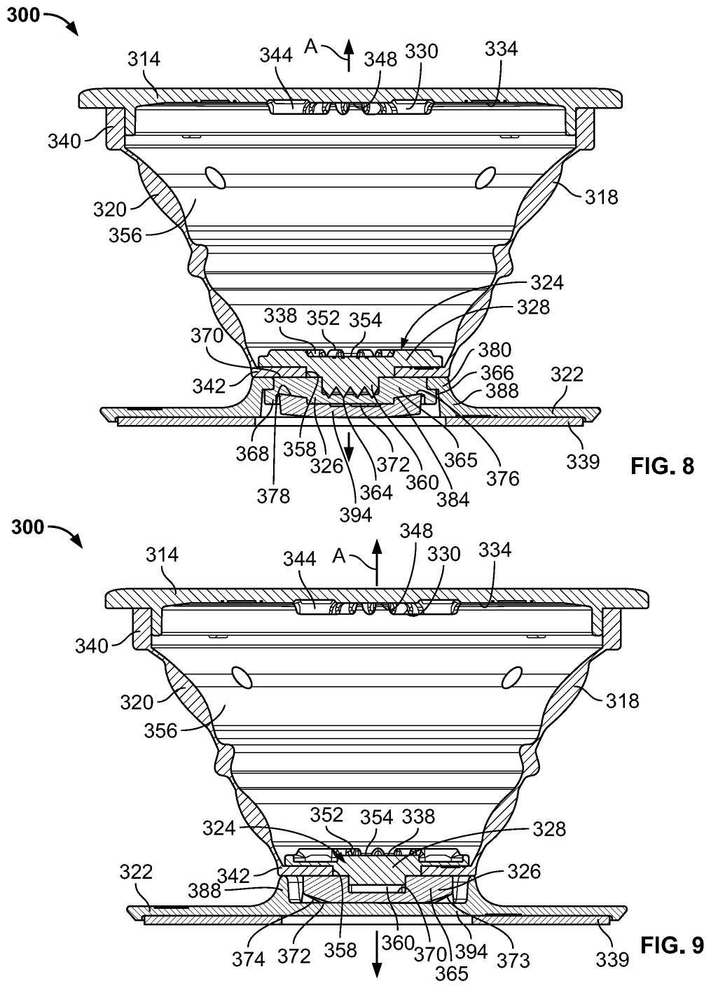

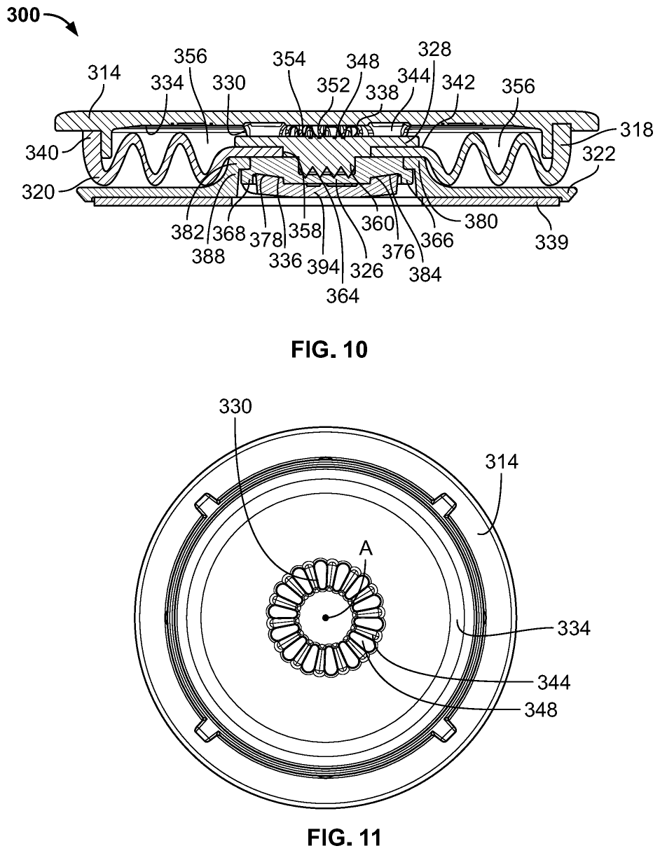

Turning to FIGS. 6-10, the third example expandable device 300 is provided in further detail. As with the expandable devices 100, 200, the expandable device 300 includes a button 314, a body 318 attached to the button 314, and a platform 322 that is attachable to a portable electronic device (not shown), a case for a portable electronic device, or other desired component. The body 318 and/or the button 314 define the storage receptacle 302. The body 318 is movable between an expanded configuration, as shown in FIGS. 6-9, and a collapsed configuration, as shown in FIG. 10. A locking device 324, which is hidden from view in FIG. 6 and is shown in FIG. 7, is disposed between the body 318 and the platform 322 to rotatably and releasably couple the body 318 to the platform 322. The locking device 324 is movable between an unlocked configuration, in which the body 318 is removable from the platform 322, and a locked configuration, in which the body 318 is secured to the platform 322. When the body 318 is in the expanded configuration, the body 318 may rotate freely about a longitudinal axis A relative to both the platform 322 and the locking device 324. The body 318 is configured to rotate with the locking device 324, and therefore move the locking device 324 from a locked configuration to an unlocked configuration, for example, only when the body 318 is in the collapsed configuration. As shown in FIGS. 8-10, an engaging member 330 carried by an inner surface 334 of the button 314 is configured to engage with a mating surface 338 of the locking device 324 when the device 300 in in the collapsed configuration. When the button 314 and body 318 rotate about the longitudinal axis A in the collapsed configuration, the engaging member 330 of the button 314 engages the locking device 324 such that the locking device 324 is rotatable relative to the platform 322 between an unlocked configuration, in which the body 318 is removable from the platform 322, and a locked configuration, in which the body 318 is secured to the platform 322. The locking device 324 also rotates about the axis A relative to the platform 322 from the locked configuration to the unlocked configuration.

As shown in FIG. 7, the locking device 324 includes a hub 326 and a connecting disk 328 rotatably connected to the body 318. In the locked configuration, the body 318 is rotatable relative to the locking device 324 and therefore rotatably coupled to the platform 322 by way of the locking device 324. The platform 322 has a mounting surface 339 that may include an adhesive adapted to attach the platform 322 to the portable device or the case for the portable device. The mounting surface 339 secures the platform 322 relative to the device to facilitate unlocking and locking the locking device 324. The hub 326, the connecting disk 328, the button 314, the body 318, and the platform 322 are aligned relative to the longitudinal axis A when the expandable device 300 is in the locked configuration.

The body 318 can include an accordion-like structure 318 having a collapsible wall 320. The body 318 is movable between the expanded configuration, as shown in FIGS. 6-9, and collapsed configuration, as shown in FIG. 10. The body 318 is symmetrical about the longitudinal axis A, and includes a first end 340 distal to the platform 322 and a second end 342 proximate to the platform 322. When the button 314 is attached to the first end 340 of the body 318, the wall 320 of the body 318 and the button 14 define a chamber 56. The body 18 includes an aperture 58 formed in the second end 42 of the body 318 such that the locking device 324 may be partially disposed both internally and externally relative to the body 318. At the second end 342 of the body 318, the chamber 356 has a volume sized to receive the connecting disk 328. The body 318 can be made of a flexible material, such as polyester-based thermoplastic polyurethane elastomer, that may be formed by injection molding, thermoforming, or compression molding, or may be any equivalently functional material suitable for its intended purpose.

As illustrated in FIGS. 8 through 10, the connecting disk 328 of the locking device 324 carried by the second end 342 of the body 318 and is disposed in the chamber 356 of the body 318 adjacent to the second end 342. In this configuration, the mating surface 338 of the connecting disk 328 faces the inner surface 334 of the button 314, and a second mating surface 360 extends through the aperture 358 of the second end 342 of the body 318 for coupling to the hub 326. The connecting disk 328 is disposed within the body 318 and is rotatable relative to the body 318. The connecting disk 328 rotates with the body 318 when the button 314 is attached to the first end 340 of the body 318 and engages with the first mating surface 338 of the connecting disk 328.

The engaging member 330 of the button 314 is particularly suited to connect with the mating surface 338 of the connecting disk 328. As such, locking device 324 of the device 300 is beneficially constructed so that the body 318 does not easily detach from the platform 322 when the device 300 is in use. The button 314 of the device 300 acts as a key to unlock or lock the body 318 from or to the platform 322 when the button 314 engages the locking device 324. In some examples where the locking device 324 is disposed below the body (as opposed to the button), the body acts as a key to unlock or lock the body from or to the platform.

As shown in FIG. 10, the engaging member 330 of the button 314 and the first mating surface 338 of the locking device 324 are arranged so that the engaging member 330 and the first mating surface 338 interlock (e.g., mesh, overlap, engage, mate, couple) when the inner surface 334 of the button 314 is adjacent to the mating surface 338. The inner surface 334 of the button 314 is shown in greater detail in FIG. 11. The engaging member 330 includes a plurality of protrusions 344 (e.g., teeth, ribs, studs, pegs, etc.) separated by a plurality of spaces 348 (e.g., grooves, notches, dimples, etc.), which may be arranged in a predetermined pattern or configuration that corresponds to the mating surface 338 of the connecting disk 328. In this example, the engaging member 330 includes a plurality protruding teeth 344 evenly spaced by the plurality of openings or grooves 348 in the shape of a ring. The engaging member 330 is disposed about the longitudinal axis A, and is symmetrical such that the button 314 may easily mesh with the first mating surface 338 of the connecting disk 328.

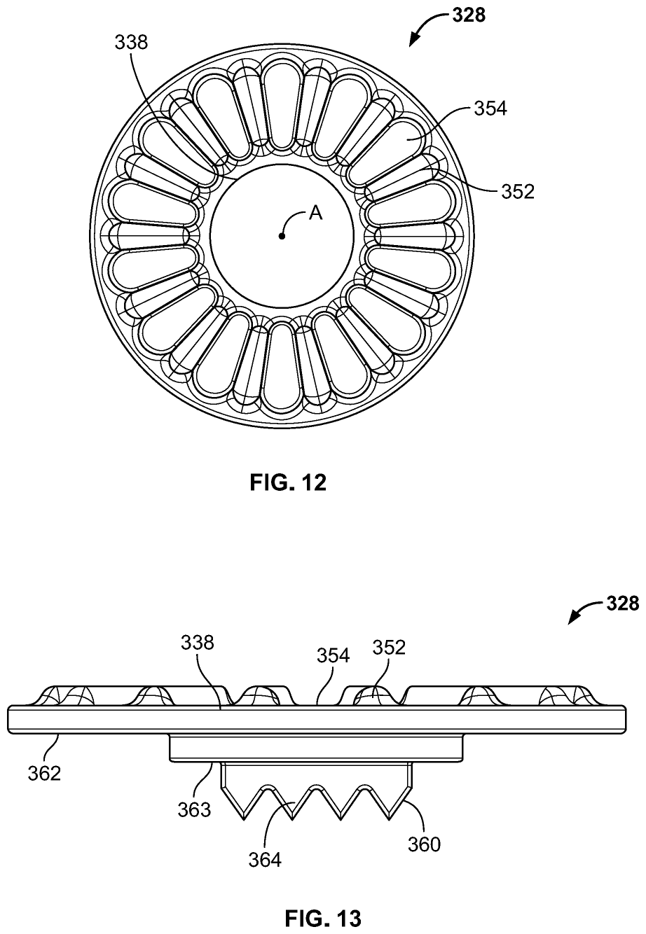

FIG. 12 illustrates the mating surface 338 of the connecting disk 328 is arranged in a pattern of protruding teeth 352 (e.g., protrusions, ribs, studs, pegs, etc.), which are evenly spaced by a plurality of grooves 354 (e.g., spaces, notches, dimples, etc.). The first mating surface 338 is symmetrical about the longitudinal axis A such that the button 314 may easily mesh with the first mating surface 338 of the connecting disk 328. Briefly returning to FIGS. 8-10, the plurality of protrusions 352 of the connecting disk 328 are aligned, and sized to fit, within the spaces 348 of the engaging member 330 of the button 314. Likewise, the plurality of grooves 354 are aligned, and sized to receive, the plurality of protrusions 344 of the button 314. Thus, when the body 318 is in the collapsed configuration, the plurality of protrusions 344, 352 of the button 314 and the mating surface 338 of the locking device 324 are interlocked and positioned to engage when the button 314 is rotated about the longitudinal axis A. In another example, the mating surface 338 and the engaging member 330 interlock or otherwise engage via an alternative locking configuration.

In FIG. 13, the second mating surface 360 of the connecting disk 328 is shown. The second mating surface 360 includes a flat area 362, a protruding portion 363 surrounded by the flat area 362 and extending axially away from the flat area 362 of the disk 328. The flat area 362 is configured to lay flat against an interior surface of the second end 342 of the body 318 and the protruding portion 363 is configured to at least partially extend through the aperture 358 of the body 318. The flat area 362 includes a smooth surface to reduce friction between the disk 328 and the body 318 such that the connecting disk 328 is free to rotate relative to the body 318 when the disk 328 is disposed within the chamber 356. A distal end 364 of the protruding portion 363 includes a plurality of angled tips. The angled tips 364 may be configured to flex, bend, or otherwise deform to mate with the hub 326. Once the protruding portion 363 engages the hub 326, the hub 326 and the connecting disk 328 may be fixed (e.g., welded, fused, etc.) together to move as a unitary locking device 324. Alternatively, the hub 326 and connecting disk 328 can be integrally formed. Unlike the flat area 362, the distal end 364 may be a textured material configured to frictionally engage with the hub 326 so that the connecting disk 328 rotates the hub 326 when the disk 328 and hub 326 are engaged.

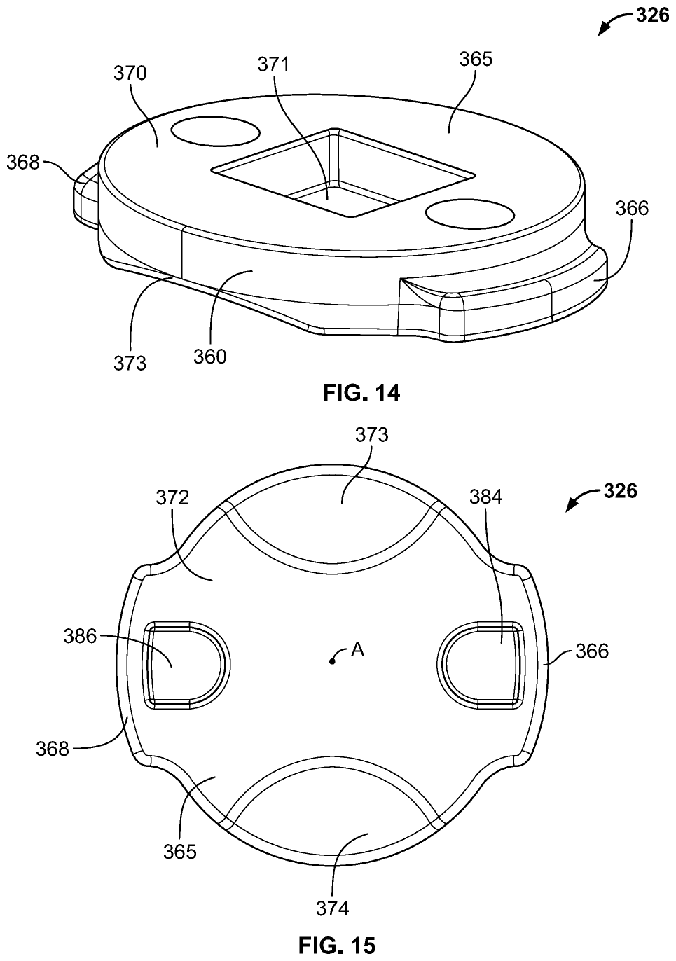

In FIGS. 14 and 15, the hub 326 is shown in greater detail. The hub 326 includes a body 365 and first and second radial wings 366 and 368 that extend outwardly from the body 365. The wings 366 and 368 are disposed on opposing sides of the body 365, and may be a resilient material such that the wings 366 and 368 may deform (e.g., bend, flex) when the wings 366 and 368 engage the platform 322. The body 365 includes a first surface 370 and a second surface 372 opposite the first surface 370. The first surface 370 is configured to mate with the second mating surface 360 of the connecting disk 328. More particularly, an opening 371 formed in the first surface 370 is sized and shaped to receive the protruding portion 363 of the second mating surface 360 of the connecting disk 328. As shown in FIG. 15, the hub 326 includes first and second curved notches or ramps 373, 374 formed in the second surface 372 to facilitate disengagement between the platform 322 and the hub 326 when the locking device 324 rotates relative to the platform 322. Specifically, the notches 373, 374 are formed to slide against protrusions 376, 378 extending from the platform 322 when the locking device 324 rotates a quarter turn (i.e., 90 degrees) about the longitudinal axis A. First and second detents 384, 386 are formed in the second surface 372 of the hub 326 and are shaped to engage with first and second protrusions 376, 378 of the platform 322 when the locking device 324 is in the locked configuration. In another example, the second surface 372 of the body 365 may have only one notch 373 or 374 or no notches. In the case where the hub 326 provide only one notch 373, the portion of the second surface 372 opposite disposed from the notch 373 may be flat or coplanar with the second surface 372. This configuration may facilitate removal of the body 318 from the platform 322. For example, as the locking device 324 is rotated out of locking engagement with the platform 322, the protrusion 376 or 378 of the platform 394 may bias the second surface 372 of the hub 326 upward and away from the platform 322.

The hub 326 and the platform 322 are arranged to rotatably couple to lock the body 318 to the platform 322. The first and second wings 366 and 368 are deformable such that they may deflect from their original position when the wings 366 and 368 engage first and second shelves 380, 382 of the platform 322 as the locking device 324 moves from the unlocked configuration to the locked configuration. The detents 384, 386 formed in the second surface 372 of the hub 326 are configured to engage with the platform 322 in the locked configuration. Specifically, each detent 384, 386 is partially formed in one of the two wings 366, 368. It will be appreciated that the second shelf 382 is substantially similar to the first shelf 380 and the wing 368 is substantially similar to the wing 366, such that any details of the first shelf 380 and the first wing 366 discussed below apply equally to the second shelf 382 and the second wing 368, respectively. In the illustrated expandable device 300, the locking device 324 includes two wings 366 and 368 and the platform 322 includes two shelves 380 and 382 corresponding to the wings 366 and 368 of the locking member 324. However, in another example device, the locking device 324 may have one wing or more than two wings, and the platform 322 may have the same number of corresponding shelves. Likewise, the platform 322 includes two protrusions 376, 378 and the hub 326 includes two detents 384, 386 corresponding to the protrusions 376, 378. However, in another example device, the hub 326 may include one detent or more than two detents, and the platform may have the same number of corresponding protrusions. The hub 326 is preferably made of a durable plastic, such as polyethylene, or a harder plastic, such as polycarbonate, that may be formed by injection molding, thermoforming, or compression molding, but may instead be formed of any other suitable and durable material including thermoplastic polyurethane, metal, fiberglass, or any combination of these materials, or any equivalently functional materials suitable for its intended purpose.

As shown in FIGS. 8-10, the hub 326 is coupled to the platform 322 when the locking device is in the locked configuration. The platform 322 includes an outer surface 387 and a collar 388 extending away from the surface 387. The collar 388 defines a cavity 390. The second shelf 382 oppositely disposed from the first shelf 380 is configured to slidably receive one of the wings 366 and 368 of the hub 326. The shelves 380 and 382 are configured to engage one of the wings 366 and 368 of the locking member 324 when the locking member 324 is in the locked configuration. A surface of each shelf 380 and 382 inhibits axial movement of the locking device 324 relative to the platform 322 when the locking device 324 is in the locked configuration. The first and second wings 366 and 368 move out of engagement with the shelves 380 and 382 when the hub 326 is rotated.

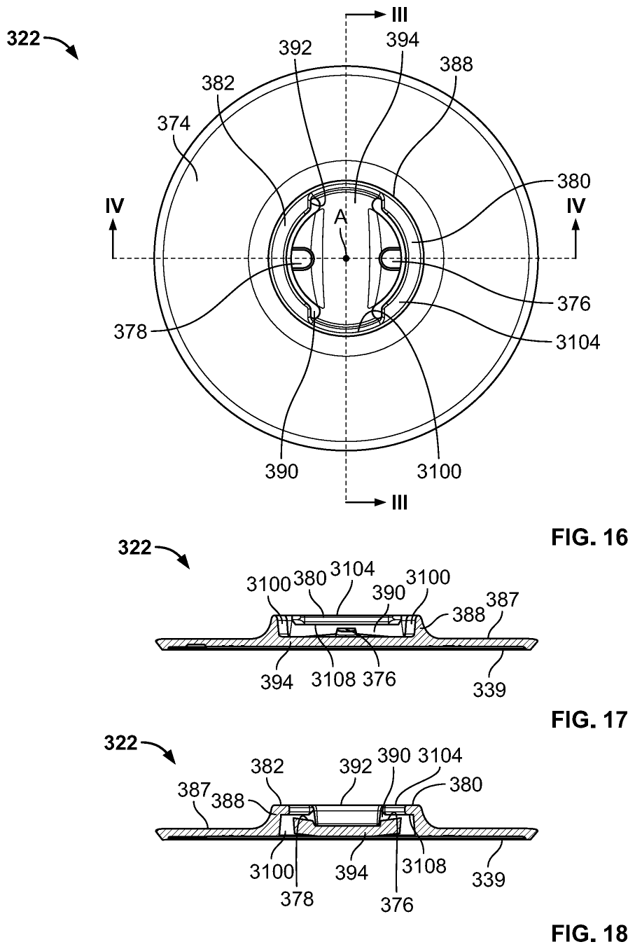

As illustrated in FIGS. 16 through 18, the first exemplary platform 322 includes the first shelf 380 extending radially inwardly from the collar 388 and into a cavity 390 formed in the platform 322. At least a portion of the locking device 324 is adapted to be removably disposed in the cavity of the platform 322 for releasably coupling the body 318 to the platform 322. The cavity 390 is partially defined by a non-circular opening 392, as shown in FIG. 16, and is shaped to receive the first and second wings 366 and 368 of the hub 326. In particular, the opening 392 is defined by first and second opposing shelves 380, 382, and an interior wall 3100 of the collar 388. The platform 322 also includes a base 394 that is recessed from the collar 388 and defines a lower boundary of the cavity 390 of the platform 322. The base 394 is connected to the inner wall 3100 of the platform 322 such that the base 394 may be co-planar with the mounting surface 339 of the platform 322, as shown in FIG. 17. The base 394 also includes first and second protrusions 376, 378 extending axially into the cavity 390 and spaced radially inwardly relative to the shelves 380, 382, respectively. The base 394 is connected to the inner wall 3100 at opposing ends, which are 90 degrees offset from the first and second shelves 380, 382. Above the opposing ends of the base 394, the collar 388 defines a radially recessed inner wall 3100, providing a clearance for the hub 326. So configured, the radial wings 366, 368 of the hub 328 may slide into the opening 392 until the radial wings 366, 368 are beneath a reference plane on which the shelves 380, 382 are disposed. The base 394 is disconnected from the inner wall 3100 directly below the first and second shelves 380, 382 such that the base 394 may flex downward relative to the shelves 380, 382 when the second surface 372 of the hub 326 engages the base 394.

As shown in FIGS. 17 and 18, the first shelf 380 of the platform 322 includes a first surface 3104 that faces the second end 342 of the body 318, and a second surface 3108 that engages with one of the first and second wings 366 and 368 of the locking member 324 when the locking member 324 moves from the unlocked configuration to the locked configuration. The platform 322 is preferably made of a durable plastic, such as polyethylene, or a harder plastic, such as polycarbonate, that may be formed by injection molding, thermoforming, or compression molding, but may instead be formed of any other suitable and durable material including thermoplastic polyurethane, metal, fiberglass, or any combination of these materials, or any equivalently functional materials suitable for its intended purpose.

To couple the locking member 324 to the platform 322, the hub 326 is disposed through the opening 392 and into the cavity 390 of the platform 322 such that the locking member 324 is at least partially disposed below first and second shelves 380, 382. The locking member 324 is rotated (e.g., 90 degrees) in either the clockwise or counterclockwise direction about the longitudinal axis A. As the locking member 324 is rotated, the first wing 366 of the hub 326 of the locking member 324 slides against the shelf 380 of the platform 322 until the protrusion 376 of the base 394 snaps into the detent 384 of the second surface 372 of the hub 326. Additionally, the hub 326 may deflect or displace the base 394 until the protrusion 376 and the detent 384 are engaged. The base 394 may be a resilient material such that the base 394 may deform (e.g., bend, flex) when engaged by the hub 326. In one example, the base 394 may bend or flex along a flexible hinge formed in the base 394 extending between opposing sides of the inner wall 3100 (i.e., where the base 394 connects to the platform 322. It will be appreciated that the second shelf 382 is substantially similar to the first shelf 380, the second wing 368 is substantially similar to the first wing 366, the second detent 386 is substantially similar to the first detent 384, and the second protrusion 378 is substantially similar to the first protrusion 376, such that any details of the first shelf 380, first wing 366, first detent 384, and the first protrusion 376 discussed above apply equally to the second shelf 382, the second wing 368, the second detent 386, and the second protrusion 378, respectively.

The mating relationships between the button 314 and the connecting disk 328, the connecting disk 328 and the hub 326, and the hub 326 and the platform 322 may be configured to provide any number of different mating engagements. For example, the hub 326 may include one or more protrusions extending from its second surface 372 to couple to one or more detents formed in the base 394 of the platform 322. In another example, the second mating surface 360 of the connecting disk 328 may not extend through the aperture 358 formed in the second end 342 of the body 318, but instead, the first surface 370 of the hub 326 may include a portion that extends into the aperture 358 of the body 318 to couple with the second mating surface 360 of the connecting disk 322. Non-limiting examples of the configuration or mating relationship between the locking member 324 and the platform 322 and/or other components of the device 300 are disclosed in U.S. application Ser. No. 15/864,402, filed Jan. 8, 2018, U.S. application Ser. No. 15/864,509, filed Jan. 8, 2018, and U.S. application Ser. No. 15/993,458, filed May 30, 2018, the entire disclosures of which are incorporated herein by reference.

The expandable device 300 may be moved from the locked configuration to the unlocked configuration by overcoming the frictional forces between the mating surfaces of the locking device 324 and the platform 322. Generally speaking, a user of the expandable device 300 may rotate the locking device 24 from the locked configuration to the unlocked configuration by collapsing the expandable device 310 such that the button 314 engages with the connecting disk 328 of the locking device 324, and then by grabbing or grasping the button 314 or body 318 and moving, e.g., rotating or twisting, the button 314 or body 318 a quarter turn (i.e., 90 degrees) in either the clockwise or counterclockwise direction about the longitudinal axis A. The button 314 engages with the locking device 324 to rotate the locking device 324 with the button 314 and body 318. In turn, the connecting disk 328 transfers the rotational motion from the button 314 to rotate the hub 326 of the locking device 324 out of engagement with the platform 322. Once the locking member 324 is in the unlocked configuration, the user may pull the body 318 away and out of the cavity 390 and through the opening 392 of the platform 322 to lock the body 318 to the platform 322.

The device 300 may be assembled by connecting the connecting disk 328 to the second end 342 of the body 318 by disposing the connecting disk 328 into the chamber 356 of the body 318. The second mating surface 360 is coupled to the first surface 370 of the hub 326 such that the hub 326 and the connecting disk 328 form a unitary locking device 324. The body 318 may be coupled to the platform 322 by disposing the hub 326 into the cavity 390 of the platform 322.

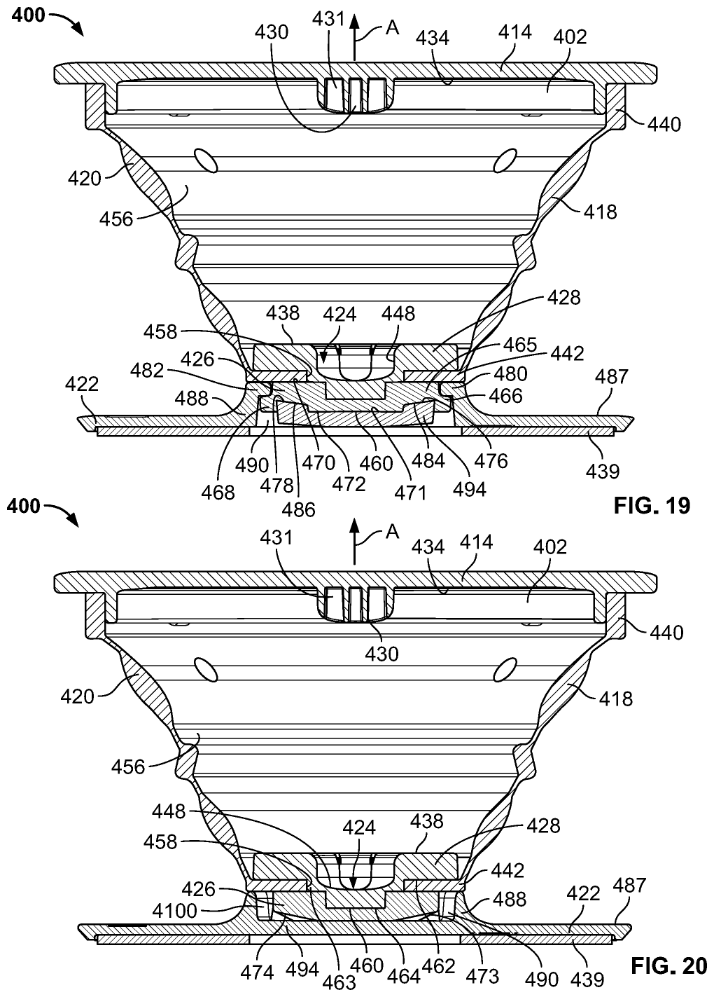

FIGS. 19 and 20 illustrate a fourth example device 400 constructed in accordance with the teachings of the present disclosure. The fourth example device 400 is similar to the device 300 of FIGS. 6-10. Thus, for ease of reference, and to the extent possible, the same or similar components of the device 400 will retain the same reference numbers as outlined above with respect to the devices 100, 200, 300, although the reference numbers will be increased by a multiple of 100.

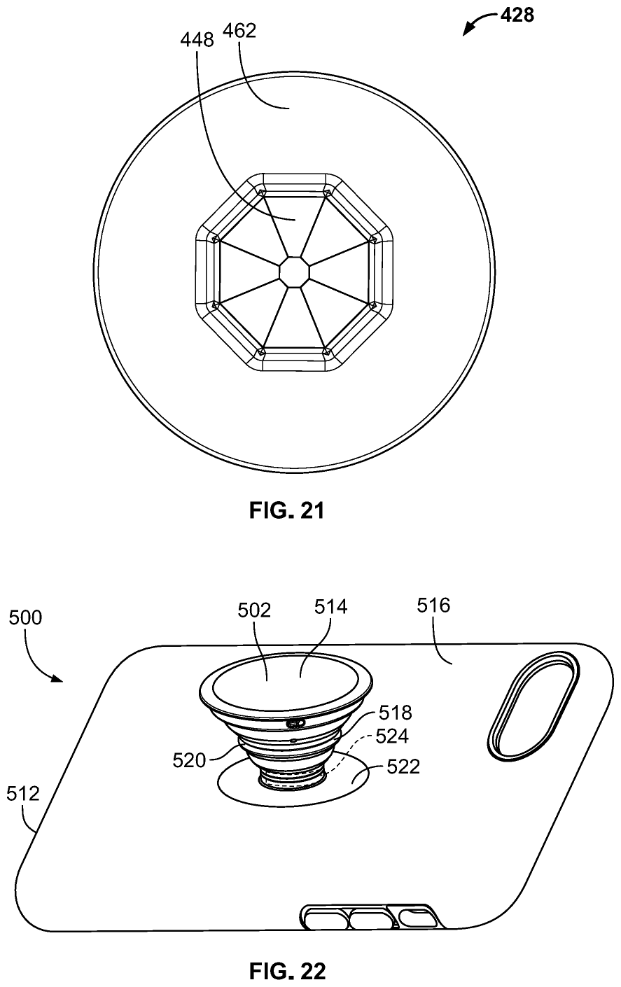

A button 414 of the fourth device 400 includes an engaging member 430 having a non-circular cross-sectional shape. The engaging member 430 includes a plurality of sides 431 configured to engage with a corresponding opening 448 or indentation formed in a first mating surface 438 of a locking device 424. As shown in FIG. 21, a connecting disk 428 of the locking device 424 includes the first mating surface 438 having a non-circular shape sized to receive the engaging member 430 of the button 414 when the device 410 is in a collapsed configuration. A body 418, a platform 422, and a hub 426 may be substantially similar to the body 318, platform 322, and hub 326 of the third device 300 previously described with reference to FIGS. 6-18. The mating surface 438 of the locking device 424 and the engaging member 430 of the button 414 may be any number of shapes and structures that facilitate engagement between the locking device 424 and the button 414. As with any of the preceding examples, a storage receptacle 402 may be formed by the button 412 and/or the body 418.

FIG. 22 illustrates a fifth example device 500 constructed in accordance with the teachings of the present disclosure. The fifth example device 500 of FIG. 22 is an example of how either the platform 522 may be integrally formed or permanently attached to a case body 512 of a portable device 510. Thus, for ease of reference, and to the extent possible, the same or similar components of the fifth device 500 will retain the same reference numbers as outlined above with respect to the devices 100, 200, 300, and 400, although the reference numbers will be increased by a multiple of 100. As shown in FIG. 22, the quick-release expandable device 500 is a protective case integrated with a platform 522 such that a body 518 of the expandable device 510 is removably coupled to a case body 512 by way of the integrated platform 522. The platform 522 may be embedded with an outer wall 516 of the case body 512, and may be formed with the case body 512 by injection molding, thermoforming, compression molding, or other techniques, such as additive manufacturing techniques. In another example, the case body 512 may be formed first and then the platform 522 may be permanently secured to the case body 512 such that the case body 512 and the platform 522 are inseparable. In some versions, the platform 522 is formed integral with the case body as opposed to a separate component attached to the case body. As with any of the preceding examples, a storage receptacle 502 may be formed by the button 512 and/or the body 518.

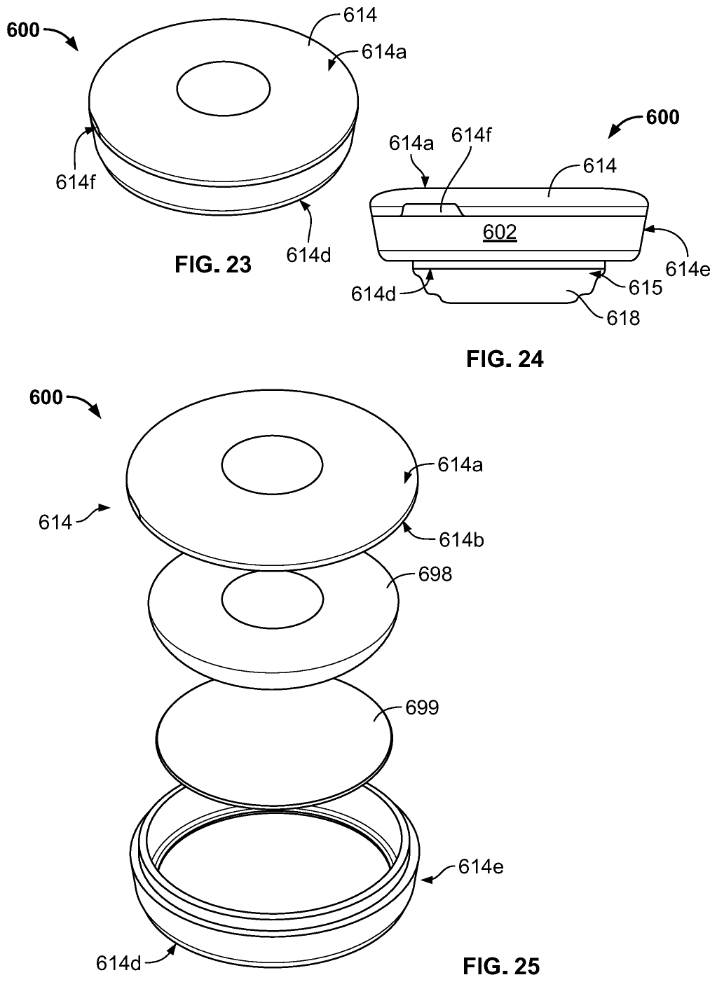

Turning to FIGS. 23-25, a sixth alternative expandable device 600 is shown. The expandable device 600 may include similar features to the expandable devices 100, 200, 300, 400, and 500, and as such, elements illustrated in FIGS. 23-25 are designated by similar reference numbers indicated on the embodiments illustrated in FIGS. 1-23, increased by 100, 200, 300, 400, or 500, respectively. Accordingly, these features will not be described in substantial detail. The expandable device 600 in this example additionally includes a button 614 having an additional notched portion 614f that allows a user to insert their finger or other object to remove and/or decouple the lid 614c from the sidewall 614e.

The inner volume 615 of the device 600 is dimensioned to accommodate a cosmetic product 698 (e.g., makeup, lip balm, etc.), and also includes a mirror 699. Specifically, the cosmetic product 698 can be positioned and/or disposed within the lid 614c, and the mirror 699 may be disposed in the base of the storage receptacle 602. In these (and other) examples, the cosmetic product 698 may be selectively removable. For example, upon using all of the cosmetic product 698, a pan or casing (not shown) surrounding the cosmetic product 698 may be decoupled from the lid 614c, and a new pan or casing containing the cosmetic product 698 may be inserted into the lid 614c. If desired, the cosmetic product 698 may be removed and/or replaced prior to being completely used. Further, in the device 600, the bottom surface 614d of the button 614 (and not the sidewall 614e) couples to the body 618. Such coupling can be achieved by any number of devices such as, for example, a threaded coupling, a friction-fit coupling, ultrasonic welding, and the like, and thus provides a user with an increased inner volume 615.

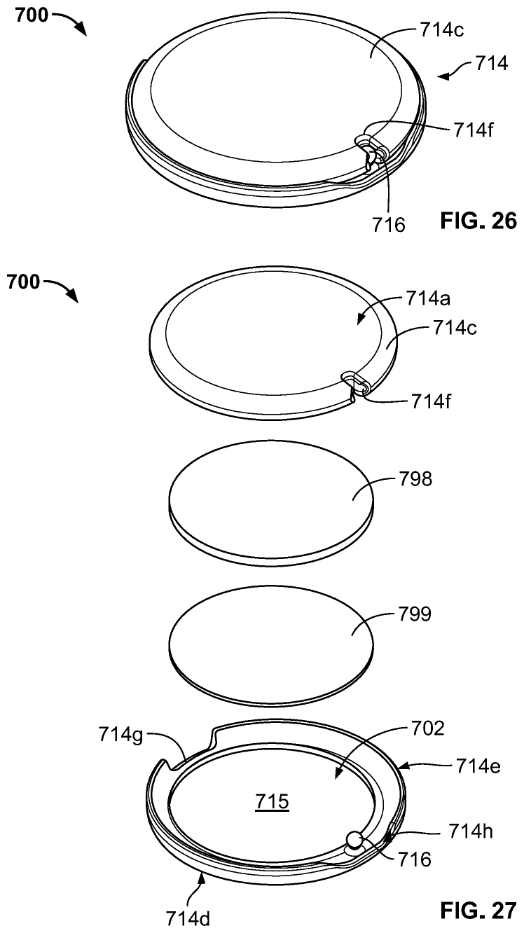

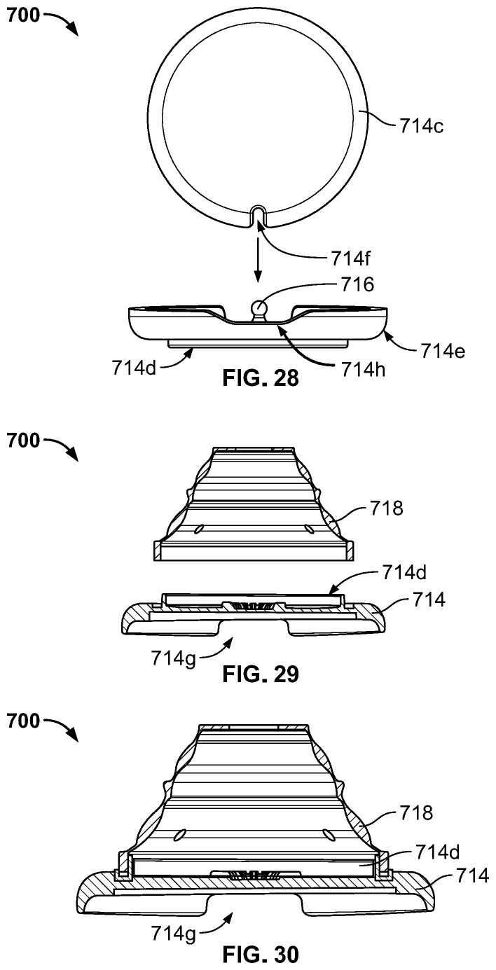

Turning to FIGS. 26-30, a seventh alternative expandable device 700 is shown. The expandable device 700 may include similar features to the expandable devices 100, 200, 300, 400, 500, and 600, and as such, elements illustrated in FIGS. 26-30 are designated by similar reference numbers indicated on the embodiments illustrated in FIGS. 1-25, increased by 100, 200, 300, 400, 500, or 600, respectively. Accordingly, these features will not be described in substantial detail. The expandable device 700 in this example additionally includes a button 714 having first and second notched portions 714f, 714g. The first notched portion 714f is disposed on the lid 714c, and is dimensioned to frictionally engage a generally ball-shaped protrusion 716 disposed on the sidewall 714e and/or the bottom 714d of the button 714. As illustrated in FIG. 28, the ball-shaped protrusion 716 is inserted into the first notched protrusion 714f, and when coupled together, the lid 714c may be rotatable relative to the sidewall 714e and/or the bottom 714d of the button 714. To open and/or remove the lid 714c, a user may insert their finger or other object into the second protrusion 714g formed on the sidewall 714e and/or the bottom 714d of the button 714. The sidewall 714e and/or the bottom 714d of the button 714 may additionally include a guiding member 714h positioned near the ball-shaped protrusion 716 that may assist in properly aligning the lid 714c with the button 714.

In this example, the device 700 includes a first mirror 798 dimensioned to be coupled to or stored within the lid 714c, and also includes a second mirror 799 having a different magnification than the first mirror 798 dimensioned to be coupled to and/or stored within the inner volume 715. In some approaches, the first mirror 798 is a magnification mirror, and the second mirror 799 is a flat mirror. In other approaches, the first mirror 798 is a flat mirror, and the second mirror 799 is a magnification mirror. Other examples are possible. In some examples, the first and second mirrors 798, 799 may be glued or otherwise adhered to their respective components. The inner volume 715 may additionally accommodate a cosmetic product or any other object, which may be removably and/or releasably stored therein. Further, similar to the device 600, and as illustrated in FIGS. 29 and 30, the bottom surface 714d of the button 714 (and not the sidewall 714e) couples to the body 718. Such coupling can be achieved by any number of devices such as, for example, a threaded coupling, a friction-fit coupling, ultrasonic welding, and the like, and thus provides a user with an increased inner volume 615.

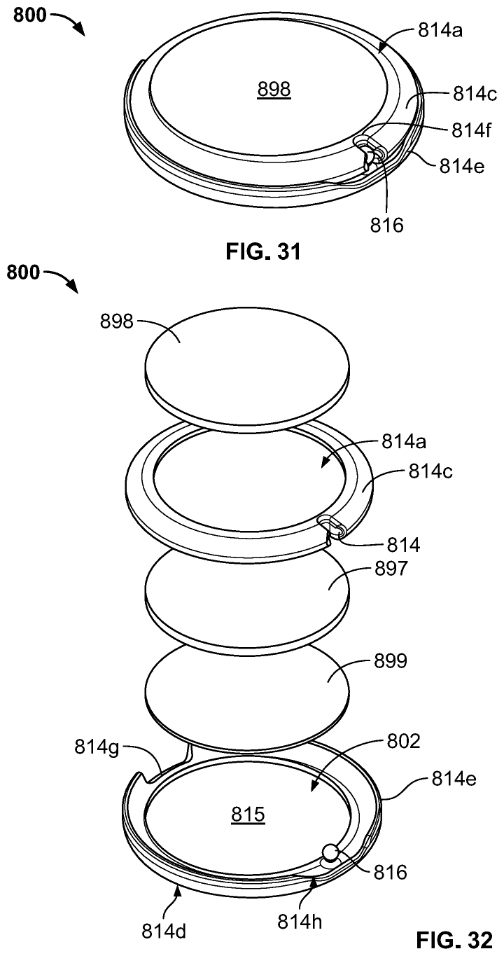

Turning to FIGS. 31 and 32, an eighth alternative expandable device 800 is shown. The expandable device 800 may include similar features to the expandable devices 100, 200, 300, 400, 500, 600, and 700, and as such, elements illustrated in FIGS. 31 and 32 are designated by similar reference numbers indicated on the embodiments illustrated in FIGS. 1-30, increased by 100, 200, 300, 400, 500, 600, or 700, respectively. Accordingly, these features will not be described in substantial detail. Like the expandable device 700, the expandable device 800 includes a button 814 having a first and second notched portions 814f, 814g, but additionally includes a recessed or inlayed lid 814h positioned at the top surface 814a of the lid 814c. The first notched portion 814f is disposed on the lid 814c, and is dimensioned to frictionally engage a generally ball-shaped protrusion 816 disposed on the sidewall 814e and/or the bottom 814d of the button 814. As before, the ball-shaped protrusion 816 is inserted into the first notched protrusion 814f, and when coupled together, the lid 814c may be rotatable relative to the sidewall 814e and/or the bottom 814d of the button 814. To open and/or remove the lid 814c, a user may insert their finger or other object into the second protrusion 814g formed on the sidewall 814e and/or the bottom 814d of the button 814.

In this example, a first mirror 898 is coupled to the lid 814c at the inlayed lid 814h portion. In some examples, a layer of glue or other adhesive is first deposited into the inlayed lid 814h, and the first mirror 898 is then inserted therein. The device 800 further includes a second mirror 899 having a different magnification than the first mirror 898, and also accommodates a cosmetic product 897 or any other object, which may be removably and/or releasably stored therein.

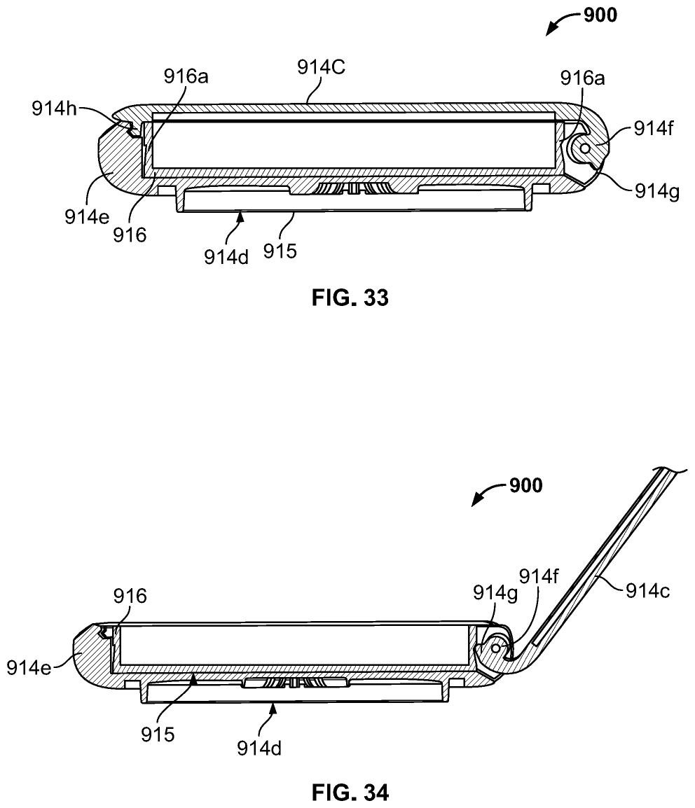

Turning to FIGS. 33 and 34, a ninth alternative expandable device 900 is shown. The expandable device 900 may include similar features to the expandable devices 100, 200, 300, 400, 500, 600, 700, and 800, and as such, elements illustrated in FIGS. 33 and 34 are designated by similar reference numbers indicated on the embodiments illustrated in FIGS. 1-32, increased by 100, 200, 300, 400, 500, 600, 700, or 800, respectively. Accordingly, these features will not be described in substantial detail. The expandable device 900 in this example additionally includes a hinge 914f that allows the lid 914c to be rotatably coupled to the sidewall 914e as well as a protrusion 914h that frictionally secures the lid 914c to the sidewall 914e.

Notably, the hinge 914f includes an engagement protrusion 914g that engages a notch 916g disposed on a container 916 upon opening the lid 914c. The container 916 may contain any object such as a cosmetic product such as lip balm. Upon engaging the notch 914g, continued opening of the lid 914c causes the container 916 to lift and/or eject to be removed from the inner volume 915 of the button 914. As a result, a user may easily access contents in the container 916, which may be replaced to accommodate different products as desired. In some examples, the engagement protrusion 914g may begin ejecting the container 916 at an angle between approximately 100° and approximately 200° relative to the bottom 914d of the button 914. Other examples are possible.

In some instances, the expandable grip accessory of the current disclosure may be in the form of a commercially available grip and stand product such as that available on www.popsockets.com. For example, U.S. Pat. No. 8,560,031, filed on Feb. 23, 2012; U.S. Pat. No. 9,970,589, filed on Nov. 9, 2017; U.S. application Ser. No. 15/615,900, filed on Jun. 7, 2017; U.S. application Ser. No. 15/679,934, filed on Aug. 17, 2017; U.S. application Ser. No. 15/803,410, filed on Nov. 3, 2017; U.S. application Ser. No. 15/808,076, filed on Nov. 9, 2017; U.S. application Ser. No. 15/864,402, filed on Jan. 8, 2018; U.S. application Ser. No. 15/864,509, filed on Jan. 8, 2018; U.S. application Ser. No. 15/906,920, filed on Feb. 27, 2018; U.S. application Ser. No. 15/922,601, filed on Mar. 15, 2018; U.S. application Ser. No. 15/952,025, filed on Apr. 12, 2018; U.S. application Ser. No. 15/993,458, filed on May 30, 2018; and U.S. application Ser. No. 16/001,723, filed on Jun. 6, 2018 each describe suitable expandable grip and stand product, which also incorporate collapsible mechanisms, the entirety of each being hereby incorporated by reference.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The patent claims at the end of this patent application are not intended to be construed under 35 U.S.C. §112(f) unless traditional means-plus-function language is expressly recited, such as “means for” or “step for” language being explicitly recited in the claim(s).

What is claimed is:

1. An expandable device for attachment to a portable electronic device, the expandable device comprising:
a platform having a top side and a bottom side, the bottom side adapted to engage a portion of the portable electronic device or a case for the portable electronic device;
a body including a first end, a second end, and a longitudinal axis, the second end of the body being operably coupled to the platform, the body being movable between an expanded configuration and a collapsed configuration;
a button operably coupled to the first end of the body, the button having an inner volume defined by a lid, an opposing bottom surface, and a sidewall; and
a storage receptacle disposable within the inner volume of the button.

2. The expandable device of claim 1, wherein the lid is rotatably coupled to the sidewall.

3. The expandable device of claim 2, wherein lid comprises a protrusion that frictionally engages with the side wall in a closed position.

4. The expandable device of claim 1, wherein the button is operably coupled to the body via at least one of:
a threaded connection;
a hinged connection;
a friction-fit connection;
a snap fit connection; or
a childproof sealing mechanism.

5. The expandable device of claim 1, further comprising a cosmetic product disposed in the storage receptacle.

6. The expandable device of claim 1, further comprising a mirror operably coupled to a surface of the lid.

7. The expandable device of claim 1, wherein the storage receptacle is dimensioned to accommodate at least one of
a cosmetic product;
a food product;
a fluid;
a medicinal product; or
an electronic component.

8. The expandable device of claim 1, wherein the storage receptacle includes a release mechanism coupled to a bottom surface thereof, the release mechanism adapted to release the body and the button from the platform.

9. The expandable device of claim 8, wherein the release mechanism is coupled to a flexible surface of the storage receptacle.

10. The expandable device of claim 8, wherein the release mechanism is coupled to a rigid surface of the storage receptacle.
